(19) United States
(12) Patent Application Publication
(10) Pub. No.: US 2003/0123375 A1
(43) Pub. Date: Jul. 3, 2003

(54) Rotary driving mechanism

(76) Inventors: Masaru Uno, Nagano (JP); Shinichi Utsumi, Nagano (JP); Shigeru Kasai, Nagano (JP); Atsushi Honda, Nagano (JP)

Correspondence Address: HOGAN & HARTSON L.L.P., 500 S. GRAND AVENUE, SUITE 1900, LOS ANGELES, CA, 90071-2611, US

(21) Appl. No.: 10/316,133

(22) Filed: Dec. 10, 2002

(30) Foreign Application Priority Data
Dec. 14, 2001 (JP) 2001-381495

(51) Int. Cl. G11B 23/00; G11B 25/00

(52) U.S. Cl. 369/263

(57) ABSTRACT

A rotary driving mechanism includes a rotary body that is rotated by a motor section, a balancing device including a plurality of balancing members mounted on the rotary body, and a vibration absorber that attenuates vibrations provided on the rotary body. The balancing device adjusts balance of the rotary body by changing positions of the balancing members at a predetermined rotational speed or greater, and the vibration absorber adjusts balance of the rotary body until the rotary body reaches the predetermined rotational speed.

### BACKGROUND OF THE INVENTION

1. Field of the Invention

The present invention relates to a rotary driving mechanisms that rotatably drive various types of information recording disks such as CDs, DVDs and CD-ROMs (hereafter generally referred to as a “rotary member” or “disk”), and more particularly to rotary driving mechanisms that can reduce swinging and vibration of a rotary shaft, which may be caused by mass eccentricity of the disk.

2. Description of Related Art

Generally, a rotary driving mechanism such as a spindle motor that rotatably drives disks has a shaft and a turntable affixed to one end of the shaft, wherein a disk is mounted on the turntable. A protrusion in the form of a truncated corn shape or a semispherical shape is provided at the center of the turntable, wherein the protrusion is inserted in a central hole of the disk to position the disk at the center of the turntable.

When the turntable is rotatably driven by a motor section, the disk is rotated together with the turntable, and data signals recorded along recording tracks of the disk are read by a reading unit such as an optical pickup device. Information signals recorded on rewritable disks can be rewritten and information signals can be written on rewritable disks. Moreover, as seen in CD-ROM driving devices in recent years, there is a tendency to increase the rotation speed of disks in order to achieve a higher processing speed to read and write information on disks; and spindle motors that can cope with higher rotational speeds are in demand.

However, as a disk is rotated at a high speed, a small mass eccentricity of the disk causes a large unbalance in the centrifugal force that is generated during the rotation of the disk, and the unbalance in the centrifugal force leads to a problem in that the shaft rotates while it swings about a rotary axis thereof. The rotation and swinging of the shaft cause vibrations, and when the vibrations are large, information signals recorded on the disk cannot be accurately read by a reading unit or information signals cannot be recorded on the disk by a writing unit.

The centrifugal force that is generated by a mass eccentricity of a disk is generally proportional to the square of the rotational speed, in other words, the higher the rotational speed, the greater the swinging and vibration of the shaft become. Therefore, swinging and vibration of a shaft, which are generated by a mass eccentricity of a disk, cause a substantial problem in increasing the rotational speed of disks.

To alleviate the problem, a disk driving device may be equipped with a balancer device having a hollow ring section that stores balancing members and a spindle motor for rotatably a driving disk mounted thereon. The spindle motor has a rotor or a spindle shaft that is integrally formed with the balancer device.

The disk driving device described above can cancel unbalances in a plane along a surface of the disk, but does not cope with dynamic unbalances. In other words, in view of the structure of the disk driving device described above, the balancer device cannot be disposed in the same plane of a disk. Therefore, the balancer, which is disposed at a position shifted in the axial direction from the disk surface, cannot simultaneously cancel vibrations caused by a mass eccentricity of the disk and vibrations in the axial direction. In other words, while an unbalance canceller may be provided on a turntable or a disk clamper, the unbalance canceller cannot be mounted in the same plane of the disk surface. As a result, a couple of forces (moment) is generated, and rotational vibrations cannot be completely removed.

Two unbalance cancellers may be disposed immediately below the turntable and over the disk damper in a manner to sandwich a disk from both sides thereof.

However, since the mass eccentricity in the height direction of a disk is not constant, a couple of forces (moment) cannot be completely cancelled. Also, the two unbalance cancellers increase the cost. There is also a problem in that a deviation in the height positions in the axial direction) between the force generated by a disk and the force generated by the unbalance canceller causes a couple of forces (moment).

Furthermore, the unbalance cancellers do not create a vibration canceling effect for vibrations in a relatively low frequency band, lower than an effective frequency band in which the unbalance cancellers is effective, and even deteriorates vibrations in such a low frequency band,

### SUMMARY OF THE INVENTION

The present invention solves the problems of the conventional technology described above, and provides a rotary driving mechanism that can cancel vibrations which could not be removed by a conventional unbalance canceller, that can remove vibrations during rotation even when locations of mass eccentricities of disks are different from one disk to another, that can reduce the size of the rotary driving mechanism and reduce the number of components by incorporating vibration absorber in a turntable, and that has a vibration canceling effect for vibrations even in a relatively low frequency band.

In accordance with an embodiment of the present invention, a rotary driving mechanism may be equipped with a rotary body that is rotated by a motor section, a plurality of balancing members mounted on the rotary body, and a vibration absorber that attenuates vibrations provided on the rotary body in a concentric configuration.

In accordance with another embodiment of the present invention, a rotary driving mechanism may be equipped with a rotary body that is attached to a rotary shaft composing a motor section, a hollow ring-shaped compartment formed in the rotary body, a plurality of balancing members stored in the hollow ring-shaped compartment, and a ring-shaped section that stores a vibration absorber for attenuating vibrations provided on an inner side in a radial direction of the hollow ring-shaped compartment.

The vibration absorber may be generally composed of a ring-shaped weight section and an elastic section for mounting the weight section to the rotary body, wherein a resonance frequency of the vibration absorber is set to be lower than an external resonance frequency to be absorbed.

The rotary body may have a structure that can retain a rotary member having a mass eccentricity.

In accordance with another embodiment of the present invention, a rotary driving mechanism may be equipped with a rotary body that is rotated by a motor section, a plurality of balancing members mounted on the rotary body, wherein the balancing members adjust balance of the rotary body by changing positions thereof at a predetermined rotational speed or greater, and a vibration absorber that attenuates vibrations provided on the rotary body, wherein the vibration absorber adjusts balance of the rotary body until the rotary body reaches a predetermined rotational speed.

The balancing members may be globular. Further, the balancing members may be freely rotatably provided around a rotary central shaft of the rotary body, and is composed of an eccentric member that rotates together with rotation of the rotary body.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a cross-sectional view of a rotary driving mechanism in accordance with an embodiment of the present invention.

FIG. 2 is a perspective view of an vibration absorber to be mounted on the rotary driving mechanism in accordance with the present embodiment.

FIG. 3 schematically shows a plan view illustrating a vibration reducing principle with a plurality of balancing members used in the rotary driving mechanism in accordance with the present embodiment.

FIG. 4 is a schematic diagram for illustrating a vibration reducing principle with an absorber used in the present embodiment.

### DESCRIPTION OF PREFERRED EMBODIMENT

A rotary driving mechanism in accordance with an embodiment of the present invention is described below with reference to the accompanying drawings.

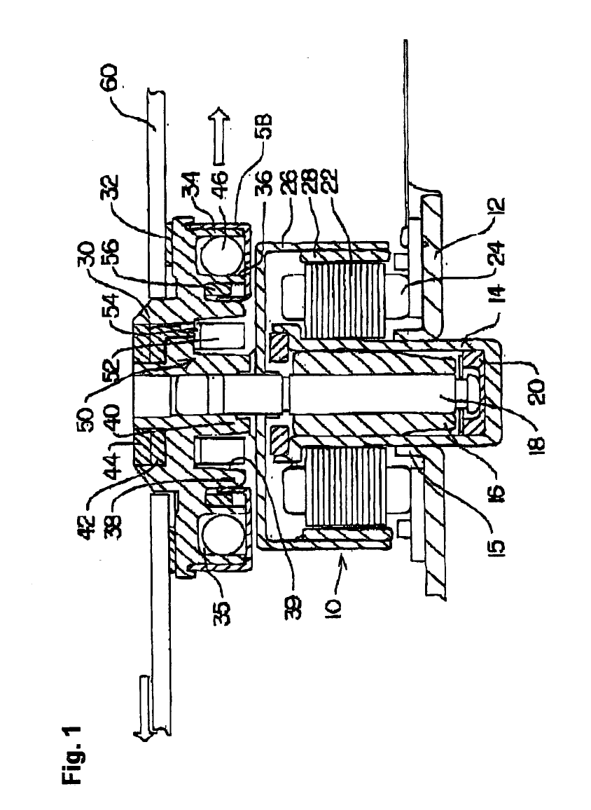

FIG. 1 shows an example of a rotary driving mechanism that can rotatably drive a disk such as a CD, DVD, CD-ROM, DVD-ROM or other types of recording media. The rotary driving mechanism includes a motor section 10 and a rotary body 30 that is rotatably driven by the motor section 10. A rotary member 60 is mounted on the rotary body 30 and rotated together with the rotary body 30. The rotary body 30 may be a turntable, and the rotary member 60 may be a disk.

FIG. 1 shows a base 12 having a cylindrical section 15 that may be formed by a burring process. A bearing holder 14 in the form of a cylinder with a bottom section is, for example, press-fitted in the cylindrical section 15 with the bottom section thereof being at a lower side, as shown in the figure, such that the bearing holder 14 forms an integral part of the base 12. A thrust bearing 20 is inserted in a bottom section of the bearing holder 4, and a single bearing 16 is fitted along an internal circumferential wall of the bearing holder 4. The bearing 16 may be composed of a sintered alloy that includes numerous pores created by sintering, and lubrication oil is impregnated in the pores. A rotary shaft 18 is inserted on the inner peripheral side of the bearing 16. A lower end of the rotary shaft 18 abuts against the thrust bearing 20, such that a thrust load acting on the rotary shaft 18 is received by the thrust bearing 20. The lubrication oil impregnated in the bearing 16 provides lubrication between the rotary shaft 18 and the bearing 16 during rotation.

A stator core 22 is affixed to an outer circumference of the bearing holder 14 above the base 12. In this example, the bearing holder 14 is inserted by press-fitting in an inner hole provided in the stator core 22 to affix itself to the outer circumference of the stator core 22. The stator core 22 includes a plurality of radially extending salient poles, and a driving coil 24 is wound on each of the salient poles. The stator core 22 and the driving coils 24 compose a stator of the motor section 10.

About an upper half portion of the rotary shaft 18 protrudes from the bearing 16 and an upper end of the bearing holder 14, and a cup-shaped rotor case 26 is fitted on the protruded portion of the rotary shaft 18 to form an integral part with the rotary shaft 18. The rotor case 16 is disposed in a manner to surround the stator section, and a cylindrical rotor magnet 28 is affixed to an inner circumferential wall surface of the rotor case 26. The rotor magnet 28 is magnetized to have N-poles and S-poles that are alternately formed at equal intervals along the circumferential direction. Inner circumferential surface of the rotor magnet 28 opposes an end face of each of the salient poles of the stator core 22 with a predetermined gap provided between them. A portion of the motor section 10 that includes the rotor case 26 and the rotor magnet 28 composes a rotor of the motor section 10.

The rotary body 30 (i.e., the turntable in the present embodiment) is affixed to an upper end section of the rotary shaft 18 that further protrudes upward from the rotor case 26. The upper end section of the rotary shaft 18 may be inserted in a central hole of the turntable and affixed to the turntable in one piece by an appropriate means such as press-fitting. The rotary body 30 may be formed from a formed resin or the like. In one embodiment, the rotary body 30 includes a plane section that receives a rotary member 60 such as a disk, a generally cylindrical section that protrudes from the plane section and is inserted in a central hole of the rotary member 60, and a cone or a truncated cone section that is continuous with the cylindrical section and functions as a guide in mounting the rotary member 60 on the rotary body 30. A disk receiving member 32 may be adhered to the plane section.

The rotary body 30 is provided with a concave recessed section in the form of a ring concentrically on the inner side in the radial direction of a portion of the rotary body 30 that is inserted in the central hole of the rotary member 60. A circular disk-shaped yoke 42 is fitted inside the concave recessed section, and a ring-shaped magnet 44 is fitted over the disk-shaped yoke 42 and affixed to the rotary body 30 by an appropriate means such as an adhesive. The magnet 44 is provided to retain a damper (not shown in the figure). Magnetic attraction force of the magnet 44 retains the damper at a predetermined location wherein the clamper, as attracted by the magnet 44, presses down the rotary member 60 against the disk receiving member 32, and the rotary member 60 can rotate together with the rotary body 60 in a unitary fashion.

The rotary body 30 includes an outer circumferential wall 34 on the outermost circumferential side on its lower side, and a partition wall 36 on the inner side in the radial direction of the outer circumferential wall 34, thereby forming a hollow circular space section 35 between the outer circumferential wall 34 and the partition wall 36. The rotary body 30 also includes a middle wall 38 on the inner side in the radial direction of the partition wall 36, and an inner circumferential wall 40 on the inner side in the radial direction of the middle wall 38. The outer circumferential wall 34, hollow circular space section 35, partition wall 36, middle wall 38 and inner circumferential wall 40 are concentrically formed. The rotary shaft 18 is inserted in a central hole formed in the inner circumferential wall 40, as described above.

A plurality of balancing members 46 composed of globular members are stored in the hollow circular space section 35 in a manner freely movable within the hollow circular space section 35. Each of the balancing members 46 may preferably be made of a material that has a large mass per unit volume, and more preferably be made of a magnetic material such as a steel ball. A magnet 56 is affixed along and to an inner wall surface of the partition wall 36 to magnetically attract the balancing members 46. As described below in greater detail, during rotation of the rotary body 30, the balancing members 46 are stably retained at appropriate positions according to the mass eccentricity of the rotary member 60; but when the rotation stops, the positions of the balancing members 46 become unstable. Accordingly, the magnet 56 is provided to magnetically attract and retain the balancing members 46 in place to prevent the balancing members 46 from randomly moving around. The hollow circular space section 35 that stores the balancing members 46 is open at its bottom section, and therefore the bottom opening section of the hollow circular space section 35 is closed by a cover 58.

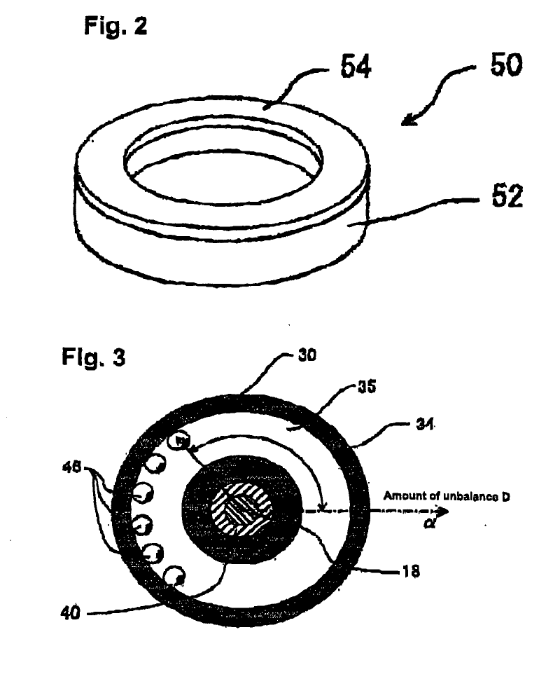

In accordance with one aspect of the present embodiment, the rotary driving device equipped with the balancing members 46 is further provided with a vibration absorber 50 to attenuate vibrations, thereby enhancing the vibration absorbing effect. The vibration absorber 60 is provided in a circular space section 39 between the middle wall 38 and the inner circumferential wall 40, located on the inner side in the radial direction of the hollow circular space section 35 that stores the balancing members 46. The circular space section 39 is concentric with the hollow circular space section 35. As indicated in FIG. 2, the vibration absorber 50 is generally composed of a ring-shaped elastic section 54 and a weight section 52 in a relatively short cylindrical shape. The weight section 52 may be affixed by an appropriate means such as adhesive to a lower surface of the elastic section 54. The elastic section 54 is affixed to a ceiling section (in the figure) of the circular space section 39. The vibration absorber 50 is affixed to the rotary body 30 through the elastic section 54 concentrically with the rotary body 30. Appropriate gaps may be provided between side surfaces of the vibration absorber 50 and side walls of the circular space section 39 such that the weight section 62 can move in the radial direction.

Currents to the driving coils 24 are controlled according to the rotational position of the rotor magnet 28 to thereby force the rotor magnet 28 in the circumferential direction by magnetic attraction and repelling forces generated between the salient poles of the stator core 22 and the rotor magnet 28, such that the rotor case 26 can be continuously rotated together with the rotor magnet 28. Also, the rotational force of the rotor case 26 is transferred to the rotary body 30 through the rotary shaft 18 to thereby rotatably drive the rotary member 60 that is clamped to the rotary body 30 in a substantially unitary fashion.

At the start of the rotation of the rotary body 30 by the motor section 10, the plural balancing members 46 are randomly located within the hollow circular space section 35. As the rotational speed of the rotary body 30 increases, the rotational speed of the rotary member 60, i.e., a disk, also increases to a higher speed. If the rotary member 60 has a mass eccentricity, and no matter how small the mass eccentricity may be, an unbalance in the centrifugal force becomes greater as the rotational speed of the rotary member 60 becomes greater, and the rotary body 30 and the rotary member 60 would substantially swing unless the balancing members 46 are provided.

Assuming that a mass eccentricity of the rotary member 60 at a certain moment works in a direction indicated by an arrow a as shown in FIG. 3, the plural balancing members 46 move and assume positions on one side of the rotary shaft 18 in a direction opposite the direction of the mass eccentricity of the rotary member 60. When the unbalance due to the mass eccentricity of the rotary member 60 is large, the plural balancing members 46 gather into a relatively narrow range; and when the unbalance due to the mass eccentricity of the rotary member 60 is relatively small, the plural balancing members 46 disperse into a wider range. In this manner, the plural balancing members 46 move to a side in a direction opposite the direction of the mass eccentricity of the rotary member 60, assume positions at which the unbalance in the centrifugal force generated by the mass eccentricity of the rotary member 60 is cancelled, and rotate together with the rotary body 30 and the rotary member 60.

In this manner, the plural balancing members 46 can reduce swinging of the rotary body 30 and the rotary member 60 even when the rotary member 60 is rotated at a high speed. However, a vibration reducing device using only the balancing members 46 cannot achieve a complete dynamic balance as described above, and cannot completely remove vibrations caused by the mass eccentricity. In contrast, by the vibration reducing device in accordance with the present embodiment, the vibration absorber 50 can substantially absorb any extra vibrations, and therefore lower the vibration level.

Also, the balancing members 46 alone do not give their intended effect during low speed rotations, but they themselves generate vibrations. In contrast, in accordance with the illustrated embodiment, vibrations are effectively absorbed by the vibration absorber 50 even during low speed rotations.

The vibration absorber 50 that is provided concentrically with the rotary body 30 in accordance with the present embodiment can remove or absorb vibrations in a low frequency band, i.e., a frequency band in which the plural balancing members 46 do not yet spread by the centrifugal force, which cannot be removed or absorbed by the conventional vibration reducing device.

In other words, the vibration absorber 50 has a vibration absorbing property that generally absorbs vibrations in a low frequency band which may not be completely removed by the plural balancing members 46 during relative low speed rotations, and the plural balancing members 46 have a vibration absorbing property that generally absorbs vibrations in a relatively high frequency band higher than the lower frequency band during higher rotational speeds.

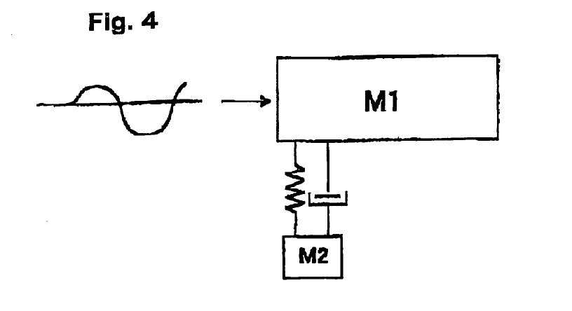

FIG. 4 shows a schematic diagram for illustrating the vibration reducing effect obtained by the vibration absorber 50. In FIG. 4, the entire mass of the rotary body is represented by M1, the mass of the weight section by M2, and the elastic section by a spring mark. A sine waveform shown in FIG. 4 indicates vibrations transmitted from outside. As indicated in FIG. 4, the vibration energy of vibrations received by the rotary body is attenuated and/or absorbed by displacements of the weight section; this reduces the vibration level. In one aspect of the present embodiment, the resonant frequency of the vibration absorber composed of the weight section and the elastic section is set lower than the frequency of vibrations applied from outside, such that the weight section M2 moves in reverse phases with respect to the main body M1. As a result, relative motion between the mass Ml and the mass M2 becomes large, and the energy consumed by the damping system composed of the elastic section becomes large, which improves the vibration reducing effect in a low frequency band.

As described above, in accordance with the illustrated embodiment, by providing the plural balancing members 46 composed of a plurality of globular members and the vibration absorber 50 provided concentrically with the rotary body 30, vibrations in a relatively high frequency band, which present major vibration components, are removed. Furthermore, the remaining vibration components in a relatively low frequency band are absorbed and removed by the vibration absorber 50 that is composed of the weight section 52 and the elastic section 54. As a result, even when there are variations in the amount of displacement of the center of gravity and the height of the center of gravity among rotary members 60 such as disks, and thus various mass eccentricities are present, their vibration level can be sufficiently reduced.

Also, in accordance with the embodiment of the present invention, unbalance cancellers do not need to be disposed on both sides of the rotary body like the conventional device. Instead, in accordance with the embodiment of the present invention, the vibration reducing effect can be obtained by simply placing the vibration absorber 50 inside the rotary body. In addition, the vibration absorber 50 has a simple structure which includes the weight section 52 and the elastic section 51. As a result, the vibration level can be sufficiently and substantially reduced at low costs and with a relatively compact structure.

It is noted that the balancing members do not need to be composed of globular members like the present embodiment. For example, instead of the plural balancing members composed of a plurality of steel balls, the vibration reducing device in accordance with the present invention can use an eccentric member that is freely rotatably provided around the rotational central axis of the rotary body, and rotates with the rotation of the rotary body. The eccentric member may be composed of, for example, a circular disk member with a shaft hole provided at an off-centered location, or a leaf-shaped plate member with a shaft hole provided in one end section thereof. In other words, the eccentric member may have center of gravity off-centered from the rotational center. Also, either a single eccentric member or a plurality of eccentric members can be provided.

In accordance with the present invention, a plurality of balancing members remove vibrations in a relatively high frequency band, which present major vibration components, and a vibration absorber provided concentrically with the rotary body absorbs and removes the remaining vibration components in a relatively low frequency band. As a result, even when there are variations in the amount of displacement of the center of gravity and the height of the center of gravity among rotary members such as disks such that various mass eccentricities are present, their vibration level can be sufficiently lowered.

Also, in accordance with the present invention, the vibration reducing effect can be obtained by simply placing a vibration absorber inside the rotary body. In addition, the vibration absorber can have a simple structure composed of a weight section and an elastic section, for example, without any problem. As a result, the vibration level can be sufficiently and substantially reduced at low costs and with a relatively compact structure.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A rotary driving mechanism:
a rotary body that is rotated by a motor section;
a balancing device mounted on the rotary body; and
a vibration absorber that attenuates vibrations, concentrically provided on the rotary body.

2. A rotary driving mechanism according to claim 1, wherein the rotary body includes a first concentric circular storage section that contains the balancing device and a second concentric circular storage section that contains the vibration absorber wherein the second concentric circular storage section is located inner side in a radial direction of the first concentric circular storage section.

3. A rotary driving mechanism according to claim 2, wherein the vibration absorber is composed of a weight section and an elastic section connected to the weight section.

4. A rotary driving mechanism according to claim 3, wherein the second concentric circular storage section defines a generally channel shaped cross section having a bottom wall and circumferential side walls, and the vibration absorber is affixed to the bottom wall of the second concentric circular storage section.

5. A rotary driving mechanism according to claim 4, wherein gaps are provided in the radial direction between the vibration absorber and each of the side walls of the second concentric circular storage section such that the vibration absorber is moveable in the radial direction.

6. A rotary driving mechanism according to claim 4, wherein the elastic section of the vibration absorber is affixed to the bottom wall of the second concentric circular storage section.

7. A rotary driving mechanism according to claim 6, wherein gaps are provided in the radial direction between the vibration absorber and each of the side walls of the second concentric circular storage section such that the vibration absorber is moveable in the radial direction.

8. A rotary driving mechanism according to claim 2, wherein the vibration absorber is composed of a ring-shaped weight section and an elastic section attached to the weight section, wherein a resonance frequency of the vibration absorber is set to be lower than an external resonance frequency to be absorbed.

9. A rotary driving mechanism according to claim 8, wherein the vibration absorber has a vibration absorbing property that generally absorbs vibrations in a low frequency band which are not removed by the balancing device, and the balancing device has a vibration absorbing property that generally absorbs vibrations in a relatively high frequency band higher than the lower frequency band.

10. A rotary driving mechanism according to claim 1, wherein the rotary body has a retaining surface that retains a rotary member having a mass eccentricity.

11. A rotary driving mechanism having a motor section including a rotary shaft, the rotary driving mechanism comprising:
a rotary body that is attached to the rotary shaft of the motor section;
a first ring-shaped hollow section formed in the rotary body;
a plurality of balancing members stored in the first ring-shaped hollow section;
a second ring-shaped hollow section formed in the rotary body; and
a vibration absorber for attenuating vibration stored in the second ring-shaped hollow section.

12. A rotary driving mechanism according to claim 11, wherein the second ring-shaped hollow section is located inner side in a radial direction of the first ring-shaped hollow section.

13. A rotary driving mechanism according to claim 12, wherein the vibration absorber is composed of a weight section and an elastic section connected to the weight section.

14. A rotary driving mechanism according to claim 13, wherein the second ring-shaped hollow section defines a generally channel shaped cross section having a bottom wall and circumferential side walls, and the vibration absorber is affixed to the bottom wall of the second ring-shaped hollow section.

15. A rotary driving mechanism according to claim 13, wherein gaps are provided in the radial direction between the vibration absorber and each of the side walls of the second ring-shaped hollow section such that the vibration absorber is moveable in the radial direction.

16. A rotary driving mechanism according to claim 13, wherein the elastic section of the vibration absorber is affixed to the bottom wall of the second ring-shaped hollow section.

17. A rotary driving mechanism according to claim 16, wherein gaps are provided in the radial direction between the vibration absorber and each of the side walls of the second ring-shaped hollow section such that the vibration absorber is moveable in the radial direction.

18. A rotary driving mechanism according to claim 12, wherein the vibration absorber is composed of a ring-shaped weight section and an elastic section attached to the weight section, wherein a resonance frequency of the vibration absorber is set to be lower than an external resonance frequency to be absorbed.

19. A rotary driving mechanism according to claim 18, wherein the vibration absorber has a vibration absorbing property that generally absorbs vibrations in a low frequency band which are not removed by the plurality of balancing members, and the plurality of balancing members has a vibration absorbing property that generally absorbs vibrations in a relatively high frequency band higher than the lower frequency band.

20. A rotary driving mechanism according to claim 11, wherein the rotary body has a retaining surface that retains a rotary member having a mass eccentricity.

21. A rotary driving mechanism comprising:
a rotary body that is rotated by a motor section;
a balancing device including a plurality of balancing members mounted on the rotary body, wherein the balancing device adjusts balance of the rotary body by changing positions of the balancing members at a predetermined rotational speed or greater; and
a vibration absorber that attenuates vibrations provided on the rotary body, wherein the vibration absorber adjusts balance of the rotary body until the rotary body reaches the predetermined rotational speed.

22. A rotary driving mechanism according to claim 21, wherein each of the balancing members is globular.

23. A rotary driving mechanism according to claim 21, wherein the balancing device is an eccentric member that rotates together with rotation of the rotary body, and freely rotatable around a rotary central shaft of the rotary body.
